(19) United States
(12) Patent Application Publication
(10) Pub. No.: US 2005/0079309 A1
(43) Pub. Date: Apr. 14, 2005

(54) Duct structural member

(76) Inventors: Susumu Okairi, Ibaraki-shi (JP); Tsuyoshi Sugauchi, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/940,931

(22) Filed: Sep. 15, 2004

(30) Foreign Application Priority Data
Sep. 17, 2003 (JP) 2003-324731

(51) Int. Cl. B32B 1/08

(52) U.S. Cl. 428/36.9

(57) ABSTRACT

A duct structural member comprises an outer layer based on a material having a structure having a side chain in a molecule and an elasticity of 200 MPa or lower on a test method defined under JIS K7171, of among low polarity elastomers comprising carbon and hydrogen.

### BACKGROUND OF THE INVENTION

1. Field of the Invention

This invention relates to a duct structural member for constituting a duct for connection to an air conditioner, such as a cooler/heater or a ventilator in a house or building, for example.

2. Description of the Related Art

Where connecting a duct to an inlet/exit port of an air conditioner, it is a general practice to wind an aluminum adhesive tape over the outer periphery of the duct at from the air inlet/exit port.

It is widely known that the aluminum adhesive tape of this kind has an excellent adhesion to a hard material, such as rigid vinyl-chloride resin, rigid polypropylene, rigid polyethylene or various metals.

Accordingly, in case such a hard material is used as a duct outer layer material, the aluminum adhesive tape can be positively wound over the outer periphery of the duct, thus enabling favorable connection to the inlet/exit port. However, there is a problem that the duct is to lower in flexibility due to its rigidity, so that it is actually not used as a duct outer layer material.

On the other hand, non-rigid vinyl-chloride resin excellent in adhesion to an aluminum adhesive tape is utilized as an outer layer material of the duct despite of a non-rigid material. However, due to the recent tendency of departure from vinyl-chloride, studies have being made on a high-polarity material such as ethylene vinylacetate copolymer (EVA) as disclosed in Japanese Patent Laid-Open Number 2003-49982 (JP-A-2003-49982), as a substitute material.

However, in the case of such a vinyl-chloride substitute resin material with a high polarity, the material itself is inferior in heat resistance and, particularly, not suited as an outer layer material of a duct.

Conversely, in the case of a vinyl-chloride substitute resin material with a low polarity, the material itself is excellent in heat resistance. Nevertheless, studies are less in progress because of the general recognition that it is inferior in adhesion to the aluminum adhesive tape.

### BRIEF SUMMARY OF THE INVENTION

It has been found that a resin, even though low in polarity generally recognized inferior in adhesion to an aluminum adhesive tape, has a good adhesion to an aluminum adhesive tape provided that having a particular structure and property. The present invention aims at providing a duct structural member less influential on environment, excellent in flexibility and heat insulation and well in adhesion to an aluminum adhesive tape by using a low polarity resin as a duct outer layer material.

In order to achieve the foregoing object, a duct structural member of the present invention is characterized by comprising: an outer layer based on a main material having a structure having a side chain in a molecule and an elasticity of 200 MPa or lower on a test method defined under JIS K7171, of among elastomers comprising carbon and hydrogen and having a solubility parameter of 18 (J/cm³)^{1/2}. Incidentally, JIS K7171 is a Japanese Industrial Standard prepared by translating ISO 178: 1993 (plastics—Determination of flexural properties) without changing the technical matters and rating forms.

This can provide a duct structural member which is less influential on environment, excellent in flexibility and heat insulation, well in adhesion to an aluminum adhesion tape and capable of stably maintaining a connection to an air conditioning equipment through an aluminum adhesive tape over a long term.

Specifically, an outer layer uses 1,2polybutadiene as a main material. This can improve the tensile strength and tear strength of the duct. Moreover, the outer layer itself can be easily restrained from ozone deterioration thereby improving duct weatherability. As a result, duct durability and flexibility can be maintained over a long term.

Meanwhile, an outer layer may use a mixture of polypropylene and ethylene-propylene-diene ternary copolymer and/or α-olefin. This can improve chemical resistance.

### BRIEF DESCRIPTION OF THE DRAWINGS

FIG. 1 is a longitudinal sectional view of an essential part of a duct hose according to one embodiment of the present invention;

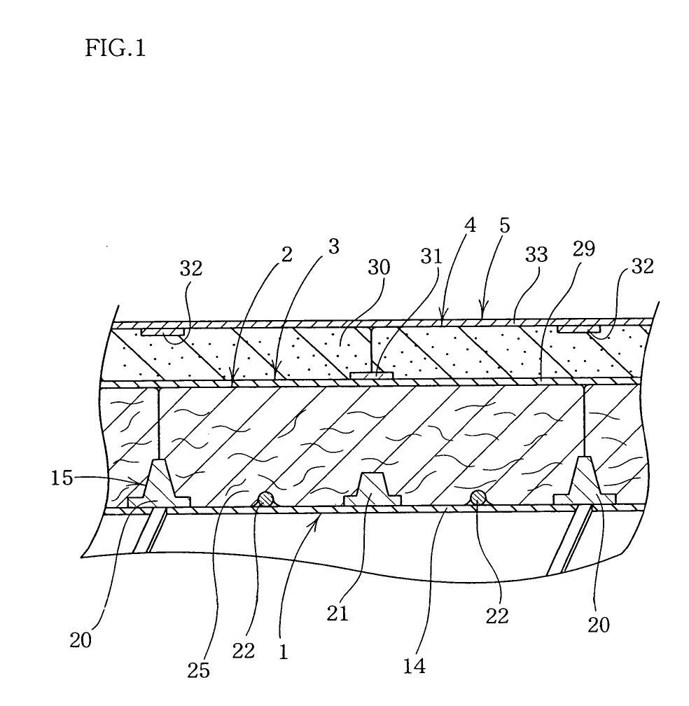

FIG. 2 is a partial broken-away side view of the same; and

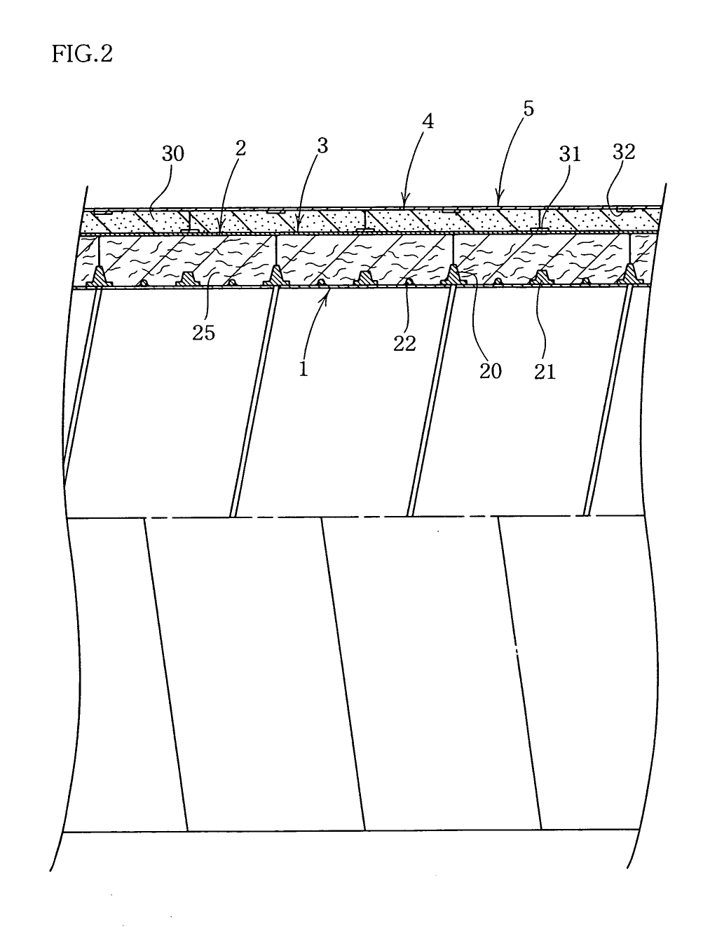

FIG. 3 is a longitudinal sectional view of a duct hose according to another embodiment.

### DETAILED DESCRIPTION OF THE INVENTION

Embodiments of the present invention will now be explained on the basis of the drawings. A duct structural member according to an embodiment of the invention is to be used as a duct hose for air conditioning. For example, it is to be connected to an air inlet/exit of an air conditioner or to an air inlet/exit of a ventilator and utilized for feeding/discharging air to/from such an air-conditioner equipment.

The duct hose is made in a structure laminated with an inner layer (1), a sound-absorbing layer (2), an intermediate layer (3), a thermal insulation layer (4) and an outer layer (5), in the order of from the inner.

The inner layer (1) is made with an air-permeable tape (14), e.g. of nonwoven fabric, wound helical and a reinforcing member (15) of rigid resin provided over the outer periphery thereof.

The reinforcing member (15) is made of an extrudate, e.g. of polypropylene. The reinforcing member (15) has a main reinforcer (20) nearly convex in a sectional form helically wound along between the adjacent end edges of the air-permeable tape (14) and thermally fused striding over the peripheral surfaces at the end edges thereof, a central reinforcer (21) nearly convex in a sectional form helically wound along a central region of the air-permeable tape (14) and thermally fused over the central peripheral surface thereof, and auxiliary reinforcers (22), (22) nearly circular in a sectional form helically wound at between the main reinforcer (20) and the central reinforcer (21) and thermally fused on the outer peripheral surface of the air-permeable tape (14).

The sound-absorbing layer (2) is made of a nonwoven fabric (25) formed in a strip nearly rectangular in a sectional form wound helical in a state the end edges thereof are abutted against each other. Incidentally, the helically wound nonwoven fabric (25) is not limited to the rectangular in section but may be nearly in a sectional form of rhombus or parallelogram.

On the inner side of the sound-absorbing layer (2), the main reinforcer (20) of the reinforcing member (15) has a tip inserted between the adjacent end edges of the helically wound nonwoven fabric (25). Meanwhile, the central reinforcer (21) is in a state intruding in a nearly central region of the nonwoven fabric (25). Furthermore, the auxiliary reinforcer (22), (22) is in a state inserted in the both ends of the nonwoven fabric (25), thus preventing the sound-absorbing layer 2 from deviating or twisting in position.

Incidentally, the sound-absorbing layer (2) is not limited to the structure of helically winding such a nonwoven fabric (25). For example, the sound-absorbing layer (2) may be constituted by an open-cell structured non-rigid resin strip of foamed polyurethane or the like helically wound in a manner abutted against at its adjacent end edges.

The intermediate layer (3) is made, for example, of a non-rigid resin tape (29) helically wound and thermally fused at its adjacent end edges. The intermediate layer (3) is not necessarily provided or may be omitted in certain cases.

The heat insulating layer (4) is made of a closed-cell structured non-rigid resin strip (30) of foamed polyethylene or the like that is formed as a strip rectangular in a sectional form and helically wound in a manner abutted against each other at its adjacent end edges. Incidentally, the heat insulating layer (4) has a thickness in a direction of hose diameter formed smaller in thickness than the sound-absorbing layer (2) in the direction of hose diameter. The helically wound non-rigid resin strip (30) is not limited to the rectangular in section but may be nearly in a sectional form of rhombus or parallelogram.

On the inner side of the heat insulating layer (4), an adhesive tape (31), formed narrow and of a material of ethylene vinylacetate copolymer (EVA) helically wound along the adjacent end edges of the strip (30), is thermally fused at between the end edges thereof and over the outer peripheral surface of the intermediate layer (3) This adheres between the adjacent end edges of the strip (30), and places the heat insulating layer (4) and the intermediate layer (3) in a state of partial adhesion.

By thus connection between the end edges of the strip (30) through the adhesion tape (31), there is no possibility that, even when the hose is bent, the strip (30) be slit at the abutment between the end edges to thereby cause a gap between the end edges. This allows the heat insulating member (4) to maintain a favorable heat insulation property.

The outer layer (5) is made based on an elastomer of a structured having a side chain in the molecule and having an elasticity of 200 MPa as tested defined under JIS K7171, of among the elastomers comprising carbon and hydrogen and having a low polarity having a solubility parameter of 18 (J/cm³)^{1/2} or less.

The elastomer having such a structure and property is excellent in flexibility and heat resistance. Moreover, it has a good adhesion to an aluminum adhesive tape despite low in polarity.

Specifically, the outer layer (5) uses a material especially suitably of monomer-based 1,2polybutadiene having a chemical structure as shown in chemical formula 1, of among the foregoing low-polarity elastomers.

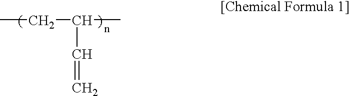

The 1,2polybutadiene, in a principal monomer unit shown by chemical formula 1, has carbons all single-bonded in its main chain and carbons double-bonded only in its side chain. Such 1,2polybutadiene is excellent in flexibility and heat resistance. Besides well adhesion to an aluminum adhesive tape, it is excellent in wetherability and tensile/tear strength. Furthermore, it has a good adhesion to an adhesive tape (32) formed of a material of EVA, referred later.

Incidentally, the outer layer (5) may employ, as a material, a mixture of 1,2polybutadiene with another resin, e.g. polypropylene unless the significance of selecting 1,2polybutadiene is lost, besides 1,2polybutadiene as a material.

Meanwhile, provided that using the above structure/characteristic of elastomer, the outer layer (5) may use a material of a mixture of polypropylene and ethylene-propylene-diene ternary copolymer (EPDM), a mixture of polypropylene and α-olefin, a mixture of polypropylene and EPDM and α-olefin, and further such a mixture added with another resin provided that the significance of selectin such a mixture is not lost. In this case, it is suitable as a material of outer layer (5) because of not only excellent in flexibility and heat resistance and good adhesion to an aluminum adhesive tape but also the capability to improving chemical resistance.

The outer layer (5) is made of a non-rigid strip (33) formed of the foregoing elastomer in a strip form and helically wound and thermally fused at its adjacent end edges.

The outer layer (5) is partially adhered on an outer peripheral surface of the heat insulating layer (4) through a narrow adhesive tape (32) of a material of EVA. Namely, on the outer periphery of the heat insulating layer (4), the adhesive tape (32), helically wound along nearly the central region of the outer peripheral surface of the non-rigid resin strip (30), is thermally fused on the inner peripheral surface of the central region of the outer peripheral surface of the non-rigid resin strip (30) and on the inner peripheral surface of the outer layer (5). This places the heat insulating layer (4) and the outer layer (5) in a state of partial adhesion.

Incidentally, by mixing an aluminum powder or an antioxidant agent in various kinds in the material of outer layer (5), the outer layer (5) may be further prevented against the deterioration due to ultraviolet rays. Furthermore, inflammability may be provided to the outer layer (5) by mixing (blending) a fire retardant in the material of outer layer (5). Meanwhile, the outer layer (5), although provided in a manner covering nearly the entire of the outer peripheral surface of heat insulating layer (4), may be partially provided covering at essential points on the outer peripheral surface of heat insulating layer (4).

The duct hose thus structured is wound with an aluminum adhesive tape over the outer periphery of the outer layer (5) thereof and connected to the air conditioning equipment. In the connection, the aluminum adhesive tape is favorably adhered to the outer layer (5) so that the connection to the air conditioner equipment can be stably maintained over a long term.

The present invention is not limited to the above embodiment but the embodiment can be naturally modified and changed within the scope of the invention. For example, the duct structural member of the invention is not limited to a tubular form as in the embodiment but may be in a box form as structured by combining panels.

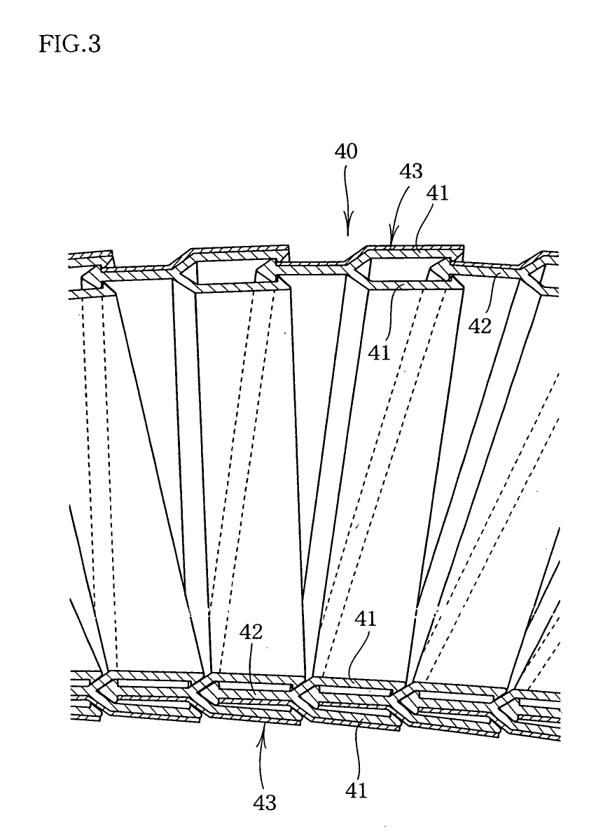

Meanwhile, without limited to the sound-absorbing heat insulation duct, it may be a duct hose as shown in FIG. 3 not having a heat insulating layer or sound-absorbing layer. The duct hose is to be used as an air discharge hose of a spot cooler or the like. Specifically, while the resin strip (40) is helically wound, a pair of clamping pieces (41), (41) are formed at one edges of the resin strip (40) between which an engaging piece (42) formed at the other end edge is inserted and engaged. The engaging piece (42) is movable in a direction of hose axis in a state urged on the opposite inner wall surfaces of the clamp pieces (41), (41). Due to this, the entire hose can be bent to a use form. Meanwhile, bending position can be maintained while resisting to the load of self weight, wind force and so on.

On the outer surface of the resin strip (40), an outer layer (43) is provided of a material of low polarity elastomer similar to that of the foregoing embodiment. Namely, the outer layer (43) is helically wound along the resin strip (40) in a manner not to cause trouble in hose bending.

While winding an aluminum adhesive tape over the outer peripheral surface of the duct hose outer layer (43), the duct hose is connected to a cooler. Due to this, the aluminum adhesive tape is favorably adhered to the outer layer (43), thus making it possible to stably keeping the connection of the cooler and the duct hose over a long term.

1. A duct structural member comprising an outer layer based on a main material having a structure having a side chain in a molecule and an elasticity of 200 MPa or lower on a test method defined under JIS K7171, of among elastomers comprising carbon and hydrogen and having a solubility parameter of 18 (J/cm³)^{1/2} or less.

2. A duct structure material comprising an outer layer based on a main material of 1,2polybutadiene.

3. A duct structure material comprising an outer layer based on a main material of a mixture of polypropylene and ethylene-propylene-diene ternary copolymer and/or α-olefin.

4. A duct structural member according to claim 1, wherein the outer layer is made by helically winding a strip, which the material is formed in a strip form, and thermally fusing or adhering between adjacent end edges thereof.

5. A duct structural member according to claim 2, wherein the outer layer is made by helically winding a strip, which the material is formed in a strip form, and thermally fusing or adhering between adjacent end edges thereof.

6. A duct structural member according to claim 3, wherein the outer layer is made by helically winding a strip, which the material is formed in a strip form, and thermally fusing or adhering between adjacent end edges thereof.

7. A duct structural member according to claim 1, wherein the outer layer is partially adhered on an outer peripheral surface of a heat insulating layer through an adhesive tape of ethylene vinylacetate copolymer as a material.

8. A duct structural member according to claim 2, wherein the outer layer is partially adhered on an outer peripheral surface of a heat insulating layer through an adhesive tape of ethylene vinylacetate copolymer as a material.

9. A duct structural member according to claim 3, wherein the outer layer is partially adhered on an outer peripheral surface of a heat insulating layer through an adhesive tape of ethylene vinylacetate copolymer as a material.

10. A duct structural member according to claim 7, further comprising a sound-absorbing layer on an inner peripheral side of the heat insulating layer.

11. A duct structural member according to claim 8, further comprising a sound-absorbing layer on an inner peripheral side of the heat insulating layer.

12. A duct structural member according to claim 9, further comprising a sound-absorbing layer on an inner peripheral side of the heat insulating layer.

13. A duct structural member according to claim 1, to be used as a duct hose for air conditioning.

14. A duct structural member according to claim 2, to be used as a duct hose for air conditioning.

15. A duct structural member according to claim 3, to be used as a duct hose for air conditioning.
